(19) United States
(12) Patent Application Publication
(10) Pub. No.: US 2023/0253199 A1
(43) Pub. Date: Aug. 10, 2023

(54) TOROIDAL ION TRAP

(71) Applicant: PerkinElmer Health Sciences, Inc., Waltham, MA (US)

(72) Inventors: Stephen D. Lammert, Glenburn, ME (US); Atanu K. Mohanty, Bangalore (IN); Shawn Johnson, Shelton, CT (US); Robert Jackson, Wilton, NH (US)

(21) Appl. No.: 18/105,308

(22) Filed: Feb. 3, 2023

Related U.S. Application Data
(60) Provisional application No. 63/306,612, filed on Feb. 4, 2022.

(51) Int. Cl. H01J 49/42

(52) U.S. Cl. CPC H01J 49/424; H01J 49/423

(57) ABSTRACT

Provided are improved toroidal ion traps and methods of design of such ion traps. Toroidal ion traps include an inner electrode comprising a first surface; an outer electrode at least partially circumferentially surrounding the inner electrode, the outer electrode comprising a second surface substantially facing the first surface, wherein the outer electrode is spaced apart from the first surface in a radial direction; a first end electrode comprising a third surface; a second end electrode comprising a fourth surface substantially facing the third surface; an axis of rotation extending through the inner electrode; and wherein: the first, second, third, and fourth surfaces define an ion confinement cavity and at least portions of each of the first, second, third, and fourth surfaces extend through or along iso-potential surfaces associated with a linear combination of toroidal multipoles to generate an electric field extending through slits in the first and second end electrodes.

### CROSS REFERENCE TO RELATED APPLICATIONS

This application depends from and claims priority to U.S. Provisional Pat. Application No: 63/306,612 filed Feb. 4, 2022, the entire contents of which are incorporated herein by reference.

### TECHNICAL FIELD

The present specification generally relates to toroidal ion traps generating improved electric field(s) for favorable ion distributions and performance for applications including mass spectrometry and ion storage.

### BACKGROUND

A focus in the development of portable and miniature chemical analysis instruments (e.g., mass spectrometers) is providing more compact, lightweight instruments while maintaining selectivity and sensitivity currently achieved in larger instrumentation. Radiofrequency trap mass analyzers play a leading role in miniature mass spectrometers due to their high sensitivity, reduced vacuum demands, and ability to perform multiple stages of mass spectrometry. Toroidal ion traps facilitate miniaturization by providing a trapping circle as opposed to a line as in conventional linear ion traps or sphere such as in three dimensional quadrupole ion traps. Such a trapping circle beneficially increases ion capacity over conventional linear ion traps of similar size; however, radial components of the trapping fields in existing toroidal ion traps are difficult to control due to the rotated geometry found in these toroidal ion traps. Another difficulty with existing systems is that, in contrast to linear and hyperbolic ion traps, toroidal ion traps possess no elements of symmetry along which it is easy to eject ions with very low loss. Such lack of symmetry elements renders field optimization in toroidal ion traps a difficult task. As a result, existing toroidal ion traps have reduced ion trajectories leading to a substantial percentage of the ions failing to exit the traps in a desired direction.

As such, new ion trap designs are needed to improve ion trajectories for improved sensitivity in mass analyzers and other devices.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are methods for creating improved ion trap devices as well as such devices with improved ion ejection trajectories relative to prior devices. A toroidal ion trap as provided according to some embodiments includes an inner electrode comprising a first surface; an outer electrode at least partially circumferentially surrounding the inner electrode, the outer electrode comprising a second surface substantially facing the first surface, wherein the outer electrode is spaced apart from the first surface in a radial direction; a first end electrode comprising a third surface; a second end electrode comprising a fourth surface substantially facing the third surface; an axis of rotation extending through the inner electrode; and wherein: the first, second, third, and fourth surfaces define a substantially annular-shaped ion confinement cavity circumferentially surrounding the axis of rotation, and at least portions of each of the first, second, third, and fourth surfaces extend through or along iso-potential surfaces associated with a linear combination of toroidal multipoles to generate an electric field extending through slits in the first and second end electrodes, wherein a linear combination of toroidal multipoles comprises at least six consecutive toroidal harmonics starting at a second order toroidal harmonic.

Optionally, the linear combination of toroidal multipoles is selected such that, when voltages are applied to the inner, outer, first end, and second end electrodes, a radial component of an electric field extending along an imaginary ejection surface extending between the slits is less than 0.05% a maximum electric field along the imaginary ejection surface optionally along the entire imaginary ejection surface extending substantially from a slit in a first electrode and a slit in a second electrode. In some embodiments, the linear combination of toroidal multipoles is selected such that, when the voltages are applied to the inner, outer, first end, and second end electrodes, an ejection direction component of the electric field along the imaginary ejection surface is linear or super-linear. Optionally, the linear combination of toroidal multipoles is selected such that, when the voltages are applied to the inner, outer, first end, and second end electrodes, an ejection direction component of the electric field along the imaginary ejection surface is linear or super-linear.

According to some embodiments of any of the foregoing, the linear combination of toroidal multipoles, is computed by multiplying a plurality of toroidal multipole coefficients by a plurality of orders or toroidal harmonics, and optionally ratios of each of the toroidal multipole coefficients to the toroidal multipole coefficient associated with the second order toroidal harmonic are rational numbers. Optionally, the plurality of multipole coefficients increase in magnitude as the order of the order of the toroidal harmonic in the linear combination of toroidal multipoles increases.

In some embodiments of any of the foregoing, the ion trap further includes comprising a symmetry plane extending substantially perpendicular to the axis of rotation through the inner electrode and the outer electrode between the first end electrode and the second end electrode. Optionally, at least one of: one or more of the first, second, third, and fourth surfaces comprise inflection points that are displaced from the symmetry plane, the axis of rotation, and an imaginary ejection surface extending between the inner and outer electrodes along an ejection direction that is parallel to the axis of rotation; or the inner electrode, outer electrode, first end electrode, and second end electrode are truncated such that end portions thereof do not overlap with one another along the ejection direction, or both. Optionally, the inner electrode comprises a first vertex extending in the ejection direction at a first radial position r₁; the outer electrode comprises a second vertex extending in the ejection direction at a second radial position r₂; and the imaginary ejection surface is disposed a radial distance R from the axis of rotation that is greater than r₁ and less than or equal to r₂. In some embodiments, R is greater than or equal to 1.0 mm and less than or equal 12.0 mm. Optionally, the first surface comprises first pair of inflection points that are disposed a distance Z_{IF} in the ejection direction from the plane of symmetry; and peaks of the first and second end electrodes are positioned along the imaginary ejection surface a distance zₒ in the direction parallel to the axis of rotation from the plane of symmetry. Optionally, R is less than 2.1 times zₒ and Z_{IF} is less than zₒ; or R is greater than 2.1 times zₒ and Z_{IF} is greater than zₒ. Further optionally, the third and fourth surfaces comprise inoculation portions where a separation distance between the third and fourth surfaces along the ejection direction as a function of radial position changes at a greater rate than outside of the inoculation portions. In some embodiments, within the inoculation portions, the third and fourth surfaces deviate from the iso-potential surfaces extend by a distance zᵢₙ in the ejection direction; and the first and second end electrodes are separated from the inner and outer electrodes by at least a maximum value of the distance zᵢₙ. In some embodiments, the inoculation portions comprise bumps surrounding the slits; and optionally widths of the inoculation portions in the radial direction equal a width of the slits multiplied by a conversion factor that is greater than or equal to 0.3 and less than or equal to 0.7.

Also provided are toroidal ion traps including a first end electrode comprising a first surface; a second end electrode comprising a second surface that is spaced apart from the first surface along an ejection direction, wherein the first and second end electrodes comprise mirror images of one another and are arranged equidistantly from a mirror plane by a distance zₒ; an inner electrode disposed radially inward of peaks of the first and second surfaces; an outer electrode disposed radially outward of the peaks; a direct current (“DC”) voltage source conductively connected to the first and second end electrodes; and a radio frequency (“RF”) voltage source conductively connected to the inner and outer electrodes, wherein the first end electrode, second end electrode, inner electrode, and outer electrode are shaped such that, in response to a RF voltage being applied to the inner and outer electrodes via the RF voltage source and a DC voltage being applied to the first and second end electrodes via the DC voltage source, an electric field is generated, the electric field comprising a radial component at a distance R from an axis of rotation that is equal to or less than 0.05% the maximum electric field in an axial direction of the device between the first and second end electrodes, optionally entirely between the first and second electrodes, optionally substantially zero between the first and second electrodes, optionally entirely between the first and second electrodes.

In some embodiments of the foregoing, the electric field comprises a z-component in a direction parallel to the axis of rotation that increases in magnitude linearly or super-linearly with increasing distance from the mirror plane.

Optionally, in some embodiments of the foregoing, the first and second end electrodes comprise slits at the distance R from the axis of rotation. Optionally, the first end electrode, the second end electrode, the inner electrode, and the outer electrode comprise portions extending along or through iso-potential surfaces associated with a linear combination of toroidal multipoles; the first and second end electrodes comprise inoculation portions surrounding the slits; within the inoculation portions, the first and second surfaces deviate from the iso-potential surfaces by a distance zᵢₙ at boundaries of the slits; and the first and second end electrodes are separated from the inner and outer electrodes by at least the distance zᵢₙ.

Also provided herein are methods of designing or making an ion trap, optionally an ion trap as provided herein or of any of the foregoing. A method includes determining the geometry for a toroidal ion trap including determining a linear combination of toroidal multipoles in a toroidal coordinate system that generates an electric field having a radial component equal to zero along an imaginary ejection surface extending through a line r = R, wherein the electric field has the radial component equal to zero for at least a distance 2*zₒ along an ejection direction; generating a plurality of iso-potential surfaces from the linear combination of toroidal multipoles; and selecting positive and negative iso-potential surfaces of the plurality of iso-potential surfaces for surfaces of end electrodes, an outer electrode, and an inner electrode for the toroidal ion trap, wherein the positive and negative iso-potential surfaces selected for the end electrodes are separated by at most the distance 2*zₒ and positioned such that the imaginary ejection surface at least partially extends therethrough.

Optionally, in the provided methods, the determining the linear combination of the toroidal multipoles comprises utilizing a least squared algorithm to determine a combination of toroidal multipoles that generates the electric field. Optionally, the method further includes altering the end electrodes to form altered end electrodes; determining a modified field generated by a toroidal ion trap comprising the altered end electrodes; subtracting the modified field from an initial field generated by the toroidal ion trap without the altered end electrodes to generate a deviation field; add the deviation field to the initial field to generate a correction field; and selecting iso-potential surfaces associated with the correction field to update the surfaces. In some aspects, the altering is by including slits along the line r = R. In some aspects, the subtracting is by subtracting the modified field from the initial field generated by the toroidal ion trap without the slits to generate a deviation field.

### BRIEF DESCRIPTION OF THE DRAWINGS

The aspects set forth in the drawings are illustrative and provided as examples only. The aspects depicted are not intended to limit the subject matter defined by the claims. The following detailed description of the illustrative aspects can be understood when read in conjunction with the following drawings, where like structure is indicated with like reference numerals and in which:

FIG. 1A schematically depicts a mass spectrometry system including a toroidal ion trap, according to one or more embodiments described herein;

FIG. 1B schematically depicts a perspective cutout view of electrodes of the toroidal ion trap of FIG. 1A, according to one or more embodiments described herein;

FIG. 1C schematically depicts a cross-sectional view of portions of the electrodes depicted in FIG. 1B, according to one or more embodiments described herein;

FIG. 1D depicts a plot of radial and ejection direction components of an electric field generated via the electrodes depicted in FIGS. 1B and 1C along an imaginary ejection surface, according to one or more embodiments described herein;

FIG. 1E depicts a first plot representing positions of inflection points of an inner electrode depicted in FIGS. 1B and 1C as a function of a size of the toroidal ion trap, according to one or more embodiments described herein;

FIG. 1F depicts a second plot representing positions of inflection points of an inner electrode depicted in FIGS. 1B and 1C as a function of a size of the toroidal ion trap, according to one or more embodiments described herein;

FIG. 2A depicts a graphical representation of a toroidal coordinate system, according to one or more embodiments described herein;

FIG. 2B depicts a flow diagram of a method of determining geometries for electrode surfaces of a toroidal ion trap, according to one or more embodiments described herein;

FIG. 3A depicts a plot of a plurality of iso-potential surfaces generated by a plurality of electrodes for a toroidal ion trap, according to one or more embodiments described herein;

FIG. 3B depicts a plot of radial and ejection direction components of an electric field generated via a set of electrodes extending along a set of the plurality of iso-potential surfaces of FIG. 3A, according to one or more embodiments described herein;

FIG. 3C depicts a plot of the radial component of the electric field depicted in FIG. 3B, according to one or more embodiments described herein;

FIG. 4A depicts electrodes of a toroidal ion trap that extend along iso-potential surfaces associated with a linear combination of toroidal multipoles including five toroidal harmonics, according to one or more embodiments described herein;

FIG. 4B depicts a plot of radial and ejection direction components of an electric field generated by the electrodes of FIG. 4A, according to one or more embodiments described herein;

FIG. 4C depicts a plot of the radial component of the electric field depicted in FIG. 4B, according to one or more embodiments described herein;

FIG. 5A depicts electrodes of a toroidal ion trap that extend along iso-potential surfaces associated with a linear combination of toroidal multipoles including six toroidal harmonics, according to one or more embodiments described herein;

FIG. 5B depicts a plot of radial and ejection direction components of an electric field generated by the electrodes of FIG. 5A, according to one or more embodiments described herein;

FIG. 5C depicts a plot of the radial component of the electric field depicted in FIG. 5B, according to one or more embodiments described herein;

FIG. 6 depicts a flow diagram of a method of correcting an electrode geometry by including inoculation portions in electrodes of a toroidal ion trap including slits, according to one or more embodiments described herein; and

FIG. 7 depicts a cross-sectional views of electrodes for a toroidal ion trap including end electrodes with slits and inoculation portions, according to one or more embodiments described herein.

### DETAILED DESCRIPTION

The present disclosure generally relates to toroidal ion traps that are constructed to generate electric fields to improve ion ejection trajectories over existing toroidal ion traps. In particular, some embodiments of the toroidal ion traps described herein generate an electrical field with a substantially zero radial component along an imaginary ejection surface extending in an ejection direction through substantially an entirety of a trapping region delineated by electrodes of the toroidal ion trap. The electric field generated by the toroidal ion traps described herein also optionally includes an ejection direction component that varies substantially linearly or super-linearly extending along the imaginary ejection surface, optionally varying substantially linearly or super-linearly with distance from a symmetry plane. The imaginary ejection surface may extend between slits on end electrodes of the toroidal ion trap such that the electric field (e.g., including the substantially zero radial component and the linear or super-linear ejection component) facilitates ejection of trapped ions through the slits in response to voltages being applied to one or more of the electrodes. The substantially zero radial component achieved by the electrodes in some embodiments beneficially prevents the ions from travelling out of alignment with the slits, thereby improving performance by increasing the portions of ions that may be detected after trapping.

Electrodes of the provided toroidal ion traps at least partially extend through or along iso-potential surfaces associated with a linear combination of toroidal multipoles to generate the electric fields. The linear combination of toroidal multipoles is optionally determined using a least squared or other suitable optimization technique to determine a combination of toroidal multipole coefficients that minimizes a difference between an electric field generated by the electrodes of the toroidal ion trap and an idealized electric field. In some embodiments, an idealized electric filed includes optionally a zero radial component along the imaginary ejection surface and optionally a substantially linear, sublinear, or super-linear ejection component along the imaginary ejection surface. The substantially linear combination of toroidal multipoles may include at least six consecutive multipoles starting at a toroidal dipole. The toroidal multipole coefficients associated with the lower order toroidal multipole may be selected to cancel out unwanted components induced by higher order multipoles. For example, a third order toroidal multipole may be included to cancel a cubic radial variation that is introduced by the toroidal quadrupole. Selection of the toroidal multipole coefficients may be performed to generate an electric field that closely approximates the idealized field described herein.

One or more electrodes of the toroidal ion traps, according to some embodiments, may also beneficially include inoculation portions to counteract electric field deviations caused by the introduction of the slits. These inoculation portions optionally include protrusions extending on either side of each slit on each end electrode. The protrusions may deviate from the iso-potential surfaces initially used to formulate the geometry of the electrodes by amounts based on a deviation field that differs from the field initially generated by the electrodes without the slits. Such inoculation portions may beneficially restore the electric field generated by the electrodes to more closely approximate the idealized fields described herein, thereby retaining the beneficial ejection trajectory achieved thereby.

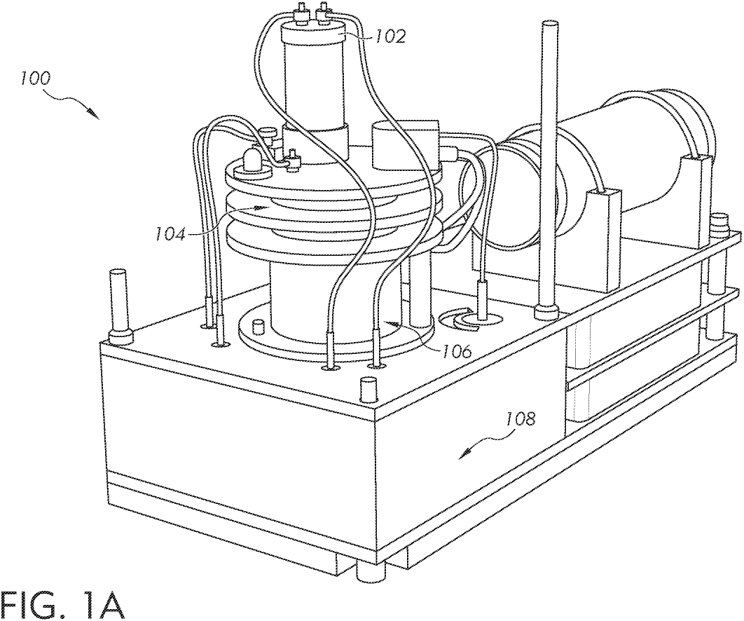

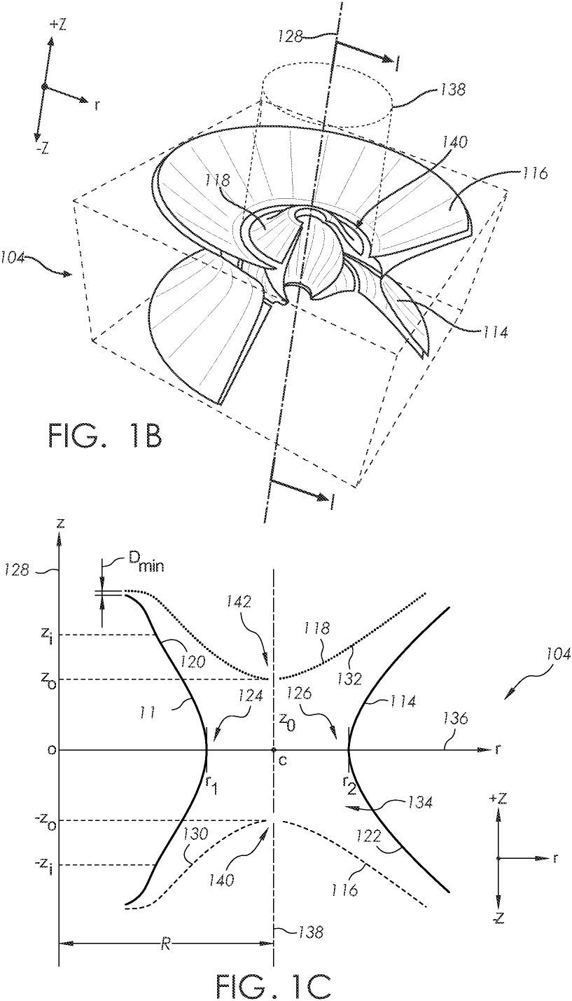

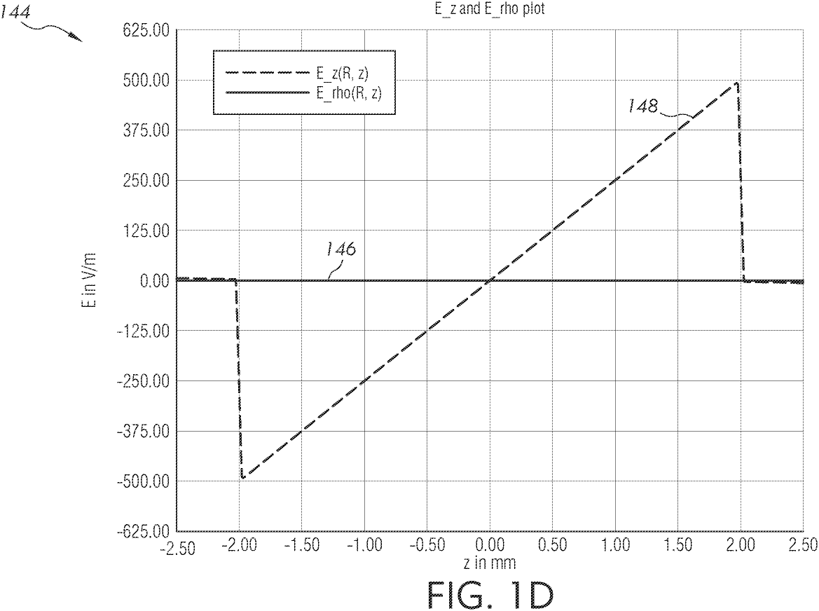

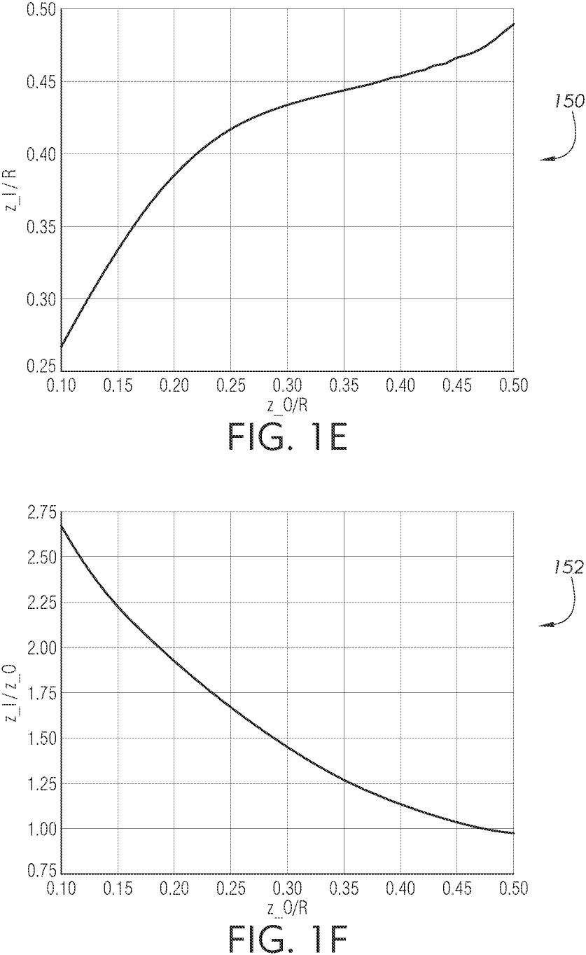

Referring now to FIG. 1A, an example mass spectrometry system 100 is shown, according to an exemplary embodiment of the present disclosure. The mass spectrometry system 100 is depicted to include an ionization source 102, a toroidal ion trap 104, a detection system 106, a power supply 108, and optionally a radio frequency (“RF”) transmitter 110 (not shown) housed within the detection system. The ionization source 102 is configured to ionize a sample by bombarding the sample with electrons. In some aspects, the ionization source 102 includes a coil that is heated via application of a power signal (e.g., from the power supply 108) to generate electrons that generate ions from a sample of interest. The ionization source 102 may utilize an applied RF field to accelerate the ions into the toroidal ion trap 104, which may trap the ions if the ions possess a mass-to-charge ratio within the stability region of the toroidal ion trap 104. The toroidal ion trap 104, shown as an electrode stack as an example, may be communicably coupled to the RF transmitter 110 (e.g., via inner and outer electrodes thereof 112 and 114 respectively, see FIGS. 1B and 1C) such that the RF transmitter 110 drives the toroidal ion trap 104 to generate an oscillating field therein. Optionally, the toroidal ion trap 104 (e.g., via the one or more of the electrodes 116, 118, 112 and 114, see FIGS. 1B and 1C) also receives a positive or negative direct current (“DC”) voltage generated via the power supply 108. The toroidal ion trap 104 may have a stability region for ions having a mass-to-charge ratio that varies depending on the magnitudes of RF and DC voltages applied to the electrodes. In some aspects, the RF and DC voltages may cause the ions to become unstable in the trapping filed to thereby cause ejection of the ions to the detection system 106. Alternatively, the ions may be ejected by applying a relatively low voltage AC signal to the end electrodes that may cause resonant ejection due to the amplification of the ion’s motion applied by the AC signal. The ions may thereby be detected by the detection system 106 and the sample used to generate the ions may be characterized.

While an exemplary mass spectrometry system 100 is depicted in FIG. 1A, it should be appreciated that the toroidal ion trap 104 (or any toroidal ion trap including electrode geometries generating the electric fields described herein) may be used in mass spectrometry systems having configurations other than the mass spectrometry system 100. Moreover, the toroidal ion trap 104 may optionally be used in applications other than mass spectrometry (e.g., ion storage, ion spectroscopy, quantum computing).

Referring now to FIGS. 1B and 1C (illustrating a cross section of the toroid), various aspects of the inner electrode 112, the outer electrode 114, the first end electrode 116, and the second end electrode 118 of the toroidal ion trap 104 will now be described in greater detail, in accordance with an example embodiment herein. As depicted in FIG. 1C, the inner electrode 112 includes a first surface 120. The outer electrode 114 circumferentially surrounds the inner electrode 112 and includes a second surface 122 facing the first surface 120. Optionally, the second surface 122 is spaced apart from the first surface 120 in a radial direction (e.g., along the r-axis in the coordinate axes depicted in FIGS. 1B and 1C). Geometries of the first and second surfaces 120 and 122 are optionally selected to at least partially extend along or through iso-potential surfaces associated with a linear combination of toroidal multipoles determined via the methods described herein. As depicted, the first and second surfaces 120 and 122 extend along iso-potential surfaces associated with the linear combination of toroidal multipoles. Such a configuration may result in the toroidal ion trap 104 including an asymmetrical geometry, where the first surface 120 differs in structure from the second surface 122. It is also envisioned that at least portions of the first and second surfaces 120 and 122 may be substantially symmetrical.

As illustrated in FIG. 1C, the first and second surfaces 120 and 122 may follow substantially hyperbolic profiles, with the first surface 120 including a first vertex 124 at a first radial position r₁ relative to an axis of rotation 128 and the second surface 122 including a second vertex 126 at a second radial position r₂ relative to the axis of rotation 128. Optionally, the axis of rotation 128 extends through a geometric center of the inner electrode 112. The axis of rotation 128 may in some aspects define an axis of rotational symmetry of the toroidal ion trap 104. That is, for any given azimuthal position relative to a reference axis in the radial direction, the cross-sectional geometry of the toroidal ion trap 104 through the r-z plane of the coordinate axes depicted in FIGS. 1B and 1C may be the same.

Referring still to FIG. 1C, the first end electrode 116 includes a third surface 130 and the second end electrode 118 includes a fourth surface 132 facing the third surface 130. The first, second, third, and fourth surfaces 120, 122, 130, and 132 may delineate boundaries of a substantially annular-shaped ion confinement cavity 134 circumferentially surrounding the axis of rotation 128. The third surface 130 and the fourth surface 132 may be symmetrical such that the toroidal ion trap 104 may optionally, but need not necessarily, include a symmetry plane 136 extending perpendicular to the axis of rotation 128. If present, the symmetry plane 136 may extend through the inner electrode 112 and the outer electrode 114 and between the first end electrode 116 and the second end electrode 118. The symmetry plane 136 may extend through the first and second vertices 124 and 126 of the first and second surfaces 120 and 122. Distances along the “ejection direction” described herein, corresponding to the positive or negative z-directions of the coordinate axes depicted in FIGS. 1B and 1C, and thus, the ejection direction optionally may be substantially parallel to the axis of rotation, may be described herein as relative distances from the symmetry plane 136, or may be relative to the distance from a desired location. For example, the third and fourth surfaces 130 and 132 are depicted to include vertices that each extend a distance zₒ from the symmetry plane 136 along the ejection direction. It is appreciated that the third and fourth surfaces 130 and 132 need not be symmetrical and the toroidal ion trap 104 does not necessarily include the symmetry plane 136.

In some embodiments, the third and fourth surfaces 130 and 132 optionally also extend along or at least partially through iso-potential lines associated with the linear combination of toroidal multipoles associated with the inner and outer electrodes 112 and 114. As described herein, the linear combination of toroidal multipoles are selected to generate an electric field extending along an imaginary ejection surface 138 extending along the ejection direction between the inner and outer electrodes 112 and 114. In some embodiments, the imaginary ejection surface 138 is a continuous or discontinuous cylindrical surface substantially circumferentially surrounding the axis of rotation 128. The imaginary ejection surface 138 may have a radius R. In some embodiments, a trapping center c of the toroidal ion trap 104 is disposed a radial distance R from the axis of rotation 128 such that the trapping center c is centrally disposed between the inner and outer electrodes 112 and 114, and may optionally be located on the symmetry plane 136. The radial distance R may determine the size and storage capacity of the toroidal ion trap 104. Illustratively, R may vary from 1.0 millimeters (mm) to 5000 mm. In some embodiments, such as when a particularly compact device is desired for portability, R may be greater than or equal to 2.0 mm and less than or equal to 12.0 mm.

The electric field generated by the inner electrode 112, the outer electrode 114, the first end electrode 116, and the second end electrode 118 may trap ions substantially at the trapping center c (e.g., forming a circle surrounding the axis of rotation 128). Variation of the voltages applied to the toroidal ion trap 104 (e.g., an RF voltage from the RF transmitter 110 or a DC voltage from the power supply 108 as may be provided to the inner and outer electrodes 112 and 114 and/or to the first and second end electrodes 116 and 118) may result in oscillation of the ions trapped substantially at the trapping center c along the imaginary ejection surface 138 such that the ions are guided out of the toroidal ion trap 104 through slits 140 and/or 142 of the first and second end electrodes 116 and 118 for detection.

As described herein, the electric field generated by the inner electrode 112, the outer electrode 114, the first end electrode 116, and the second end electrode 118 may include components in the radial direction and the ejection direction along the imaginary ejection surface 138 to facilitate the oscillating ions traveling along the ejection direction between the slits 140 and 142 to provide a relatively high ion throughput as compared to existing toroidal ion traps. In some embodiments, the imaginary ejection surface 138, along which the electric field generated via the toroidal ion trap 104 includes the radial and ejection direction components meeting the requirements described herein, extends at least partially through both of the slits 140 and 142. That is, the imaginary ejection surface 138 may extend through an entirety of the substantially annular-shaped ion confinement cavity 134 between the slits 140 and 142 along the ejection direction.

Referring now to FIG. 1D, a plot 144 of an electric field generated by the inner electrode 112, the outer electrode 114, the first end electrode 116, and the second end electrode 118 of the toroidal ion trap 104 is shown, according to an exemplary embodiment. The plot 144 depicts a radial component 146 (e.g., extending along the r-axis of the coordinate axes depicted in FIGS. 1B and 1C) and an ejection direction component 148. In the depicted example, the distance zₒ between the vertices of the first and second end electrodes (see FIG. 1C) and the symmetry plane 136 is 2.0 mm, with z = 0.0 mm being located on the symmetry plane 136. As shown, the radial component 146 is substantially zero an entirety of the distance between the first and second end electrodes 116 and 118 along the imaginary ejection surface 138 (see FIG. 1C). As used herein, the term “substantially zero,” when used in describing a radial component of an electric field generated by a toroidal ion trap, means that a magnitude of the radial component is at most 0.05% of the maximum axial field. The ejection direction component 148 is substantially linear along the imaginary ejection surface 138 between the first and second end electrodes 116 and 118. In some embodiments, the radial component 146 is substantially zero and the ejection direction component 148 is substantially linear, sublinear or super-linear between the slits 140 and 142 (e.g., along an entirety of a portion of the imaginary ejection surface 138 extending between the slits 140 and 142). In other words, the electric field having the substantially zero radial component 146 and the substantially linear, sublinear or super-linear ejection direction component 148 may extend at least partially through the slits 140 and 142. As used herein, the term “super-linear,” when used to describe an ejection direction component of an electric field, refers to a concave curve having a positive second derivative as a function of distance from the symmetry plane 136. As used herein, the term “sublinear,” when used to describe an ejection direction component of an electric field, refers to a concave curve having a negative second derivative as a function of distance from the symmetry plane 136.

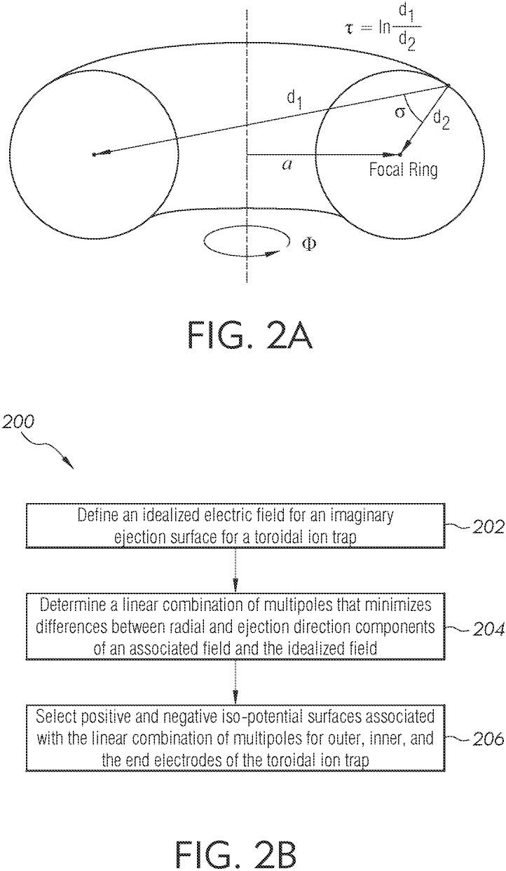

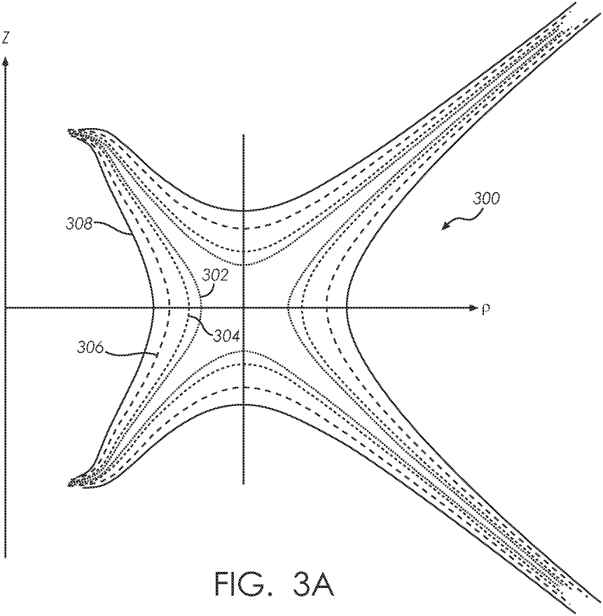

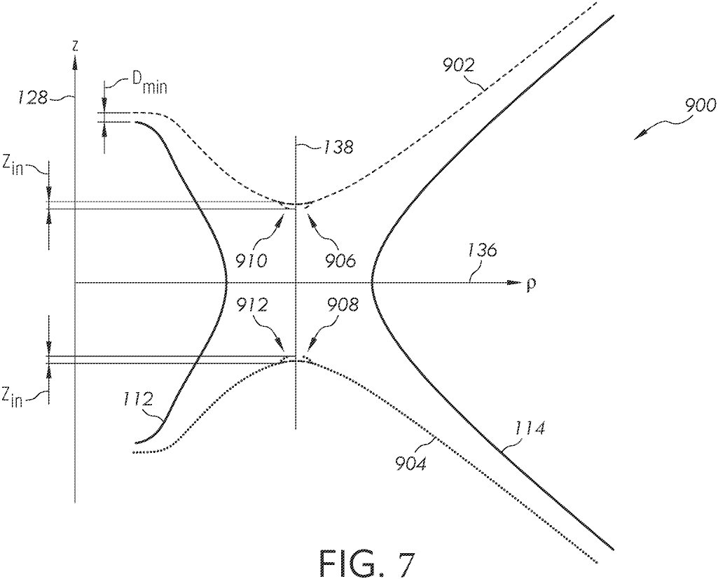

With reference to FIGS. 1B and 1C, the geometries of the inner electrode 112, the outer electrode 114, the first end electrode 116, and the second end electrode 118 of the toroidal ion trap 104 may be selected to generate an electric field including the radial and ejection components substantially as depicted in FIG. 1D or as otherwise described herein. The method for determining geometries for the electrodes is described in greater detail herein with respect to FIGS. 2 and 7. Generally, an optimization approach is used where a linear combination of toroidal multipoles is selected based on an idealized electric field (e.g., where the radial component 146 may not substantially deviate from zero within the substantially annular-shaped ion confinement cavity 134 and where the ejection direction component 148 is substantially or exactly linear). For example, a plurality of sets of toroidal multipole coefficients may be generated to compute a plurality of different linear combinations of toroidal multipoles. The set of toroidal multipole coefficients that generates an electric field that most closely approximates (e.g., possess the least root mean square error) the idealized electric field may be selected and used to generate iso-potential surfaces through which the electrodes of the toroidal ion trap 104 extend at least partially through or along. It has been determined that the linear combination of toroidal multipoles generally includes at least six multipoles starting at a second order toroidal multi-pole (e.g. the second order toroidal multipole to the seventh order toroidal multipole). The second order toroidal multipole provides the trapping field used to trap ions at the circular trapping center c (see FIG. 1C), while higher order components are used to cancel out unwanted components associated with other orders and generate the substantially zero radial component along the imaginary ejection surface 138. For example, the third order toroidal multipole may be included to cancel a cubic radial variation that may be introduced by the toroidal quadrupole.

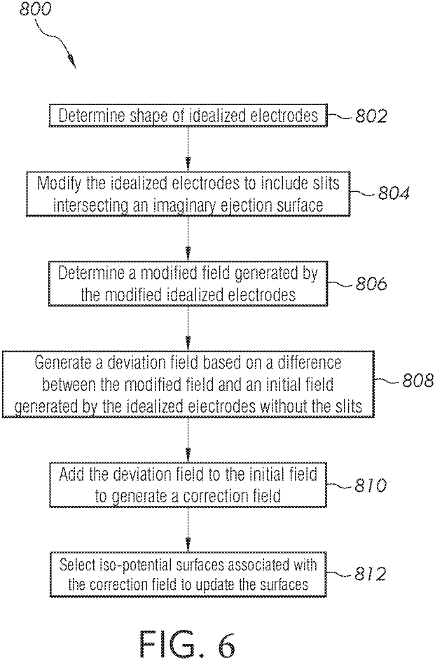

With reference to FIG. 1C, the precise shape of the first, second, third, and fourth surfaces 120, 122, 130, and 132 may depend on a variety of factors, including, but not limited to, the magnitude of the electric potential associated with the selected iso-potential surfaces, the radius R selected for the trapping center c, the distance zₒ between the vertices of the third and fourth surfaces 130 and 132 and the symmetry plane 136, a truncation position for the electrodes (e.g., the relative position of the ends of each electrode relative to the vertices thereof), and whether a segmented electrode design is used. Segmented electrode designs are described in greater detail herein with respect to FIG. 6.

In the example depicted in FIG. 1C, R = 6.0 mm, iso-potential surfaces associated with +/- 0.5 V were selected for the electrodes, and the vertices of the third and fourth surfaces 130 and 132 were designed to be a distance of 2.0 mm from the symmetry plane 136. When using such a configuration, the inner electrode 112 is depicted to include inflection points positioned a distance zᵢ from the symmetry plane 136 (e.g. displaced from the symmetry plane by distance zᵢ). In the depicted example, zᵢ is greater than zₒ, though the relative positioning between the inflection points and the vertices of the third and fourth surfaces 130 and 132 may vary depending on the implementation.

FIGS. 1E and 1F depicts plots 150 and 152, respectively, representing the positioning zᵢ of the inflection points that may be included in the inner electrode 112 in certain embodiments, respectively. The plots 150 and 152 may be associated with the inner electrode 112 when iso-potential surfaces associated +/- 0.5 V are selected from the linear combination of toroidal multipoles generated via the methods described herein. FIG. 1E depicts a plot 150 of a ratio of zᵢ/R as a function of the ratio zₒ/R. FIG. 1F depicts a plot 152 of a ratio zᵢ/zₒ as a function of the ratio zₒ/R. As shown, as the ratio zₒ/R decreases (e.g., as R increases while holding zₒ constant), the inflection points of the inner electrode 112 get closer to the symmetry plane 136. Moreover, as the ratio zₒ/R decreases, the ratio zᵢ/R also decreases. For this particular example, in accordance with the plots 150 and 152, when R is less than 2.1 times zₒ, zᵢ is less than zₒ. In embodiments, when R is greater than 2.1 times zₒ, zᵢ is greater than zₒ. These values are associated with a particular iso-potential surface associated with a particular linear combination of toroidal multipoles, and the exact positioning of any inflection points on the linear electrode 112 may vary in different examples where different iso-potential surfaces are selected and/or different linear combinations of toroidal multipoles are used.

It should be understood that embodiments are also envisioned where the inner and outer electrodes 112 and 114 are truncated closer to symmetry plane 136 than zᵢ, which would eliminate the presence of the inflection points even if the same iso-potential surfaces were selected. Even when using the same R value, zₒ value, and truncation positions as in the depicted example, the inflection points may also not be present if iso-potential surfaces associated with a different magnitude (e.g., +/- 0.125 V) are selected. As such, the precise geometry for each the electrode surfaces depicted in FIG. 1C represents only one example and other surfaces including different surface features may be present in accordance with the present disclosure. The present disclosure is not limited to any particular electrode geometry.

Referring now to FIGS. 2A and 2B, a method of generating linear combinations of toroidal multipoles that may be used to determine geometries for electrodes of the toroidal ion traps of the present disclosure is described in greater detail. FIG. 2A schematically depicts a representation of coordinates of a toroidal coordinate system. The toroidal coordinate system generally contains the coordinates denoted (σ, τ, φ), with a torus containing a focal ring of radius a.

Toroidal harmonics represent solutions to the Laplace equation in a toroidal coordinate system. An axially symmetric separable solution to the Laplace equation may be written as

$$\begin{matrix}\sqrt{cosh τ - cos σ} \left[{a}_{v} cos \left(v σ\right) + {b}_{v} sin \left(v σ\right)\right] \\ \left[{c}_{v} P {}_{v - \frac{1}{2}} \left(cosh τ\right) + {d}_{v} {Q}_{v - \frac{1}{2}} \left(cosh τ\right)\right]\end{matrix}$$

where v is an integer, aᵥ, bᵥ, cᵥ, and dᵥ are toroidal multipole coefficients; and

$$P {}_{v - \frac{1}{2}}$$

and

$${Q}_{v - \frac{1}{2}}$$

are associated Legendre functions of the first and second kind, respectively. Near the trapping circle c of the toroidal ion trap (see FIG. 1C), τ approaches infinity, so the term

$$\sqrt{cosh τ - cos σ} P {}_{v - \frac{1}{2}} \left(cosh τ\right)$$

becomes unbounded and may be discarded. A suitable expansion for the potential near the trapping circle may thus be described as

$$\begin{matrix}Ψ \left(σ , τ\right) = {a}_{o} \sqrt{cosh τ - cos σ} {Q}_{- \frac{1}{2}} \left(cosh τ\right) + \sqrt{cosh τ - cos σ} \\ \times {\sum }_{v = 1}^{∞} \left[{a}_{v} cos \left(v σ\right) + {b}_{v} sin \left(v σ\right)\right] {Q}_{v - \frac{1}{2}} \left(cosh τ\right)\end{matrix}$$

where Ψ(σ, τ) is the potential at the point (σ, τ); and aᵥ and bᵥ are toroidal even and toroidal odd multipole coefficients, respectively. In some embodiments, the toroidal even and toroidal odd multipole coefficients aᵥ and bᵥ are selected to minimize a difference between a target potential Ψ_{T} (σ, τ) associated with an idealized electric field along an imaginary ejection surface extending through the torus.

Referring now to FIG. 2B, a flow diagram of an exemplary method 200 of determining geometries for electrodes of a toroidal ion trap is depicted, according to an example embodiment. For example, the method 200 may be used to compute the geometries for the inner electrode 112, outer electrode 114, first end electrode 116, and second end electrode 118 of the toroidal ion trap 104 described herein with respect to FIGS. 1A-1F. Accordingly, reference will be made to various components of the toroidal ion trap 104 of FIGS. 1A-1F to aid in the description of the method 200. It should be understood that the method 200 may be used to form a variety of toroidal ion traps that differ in structure from the toroidal ion trap 104 and that the toroidal ion trap 104 only serves as an example.

At block 202, an idealized electric field for the imaginary ejection surface 138 of the toroidal ion trap 104 is defined. Optionally, the imaginary ejection surface 138 may be designed based on parameters used to determine the size of the toroidal ion trap 104 and extends along vertical line through c and through the slits. Optionally, the field is oriented solely along the imaginary ejection surface such that the radial component of the field is close to zero or optionally at or less than 0.05% the maximum axial field thereby minimizing the radial component of the field and constraining the ejection direction along the desired ejection surface. The z component of the electric field on the ejection axis may be linear, or in other words proportional to z. In other embodiments, the z component of the electric field can may be super-linear or sublinear. Super-linear means the slope of E_{z} increases with increasing z (positive first derivative), and sublinear means the slope of E_{z} decreases with increasing z (negative first derivative).

The idealized field E_{T} (σ, τ) may be selected to have a substantially zero radial component (or within tolerances as provided herein) along an entirety of the imaginary ejection surface 138 between the first and second end electrodes 116 and 118. Optionally, the idealized electric field E_{T} (σ, τ) is selected to have a substantially linear, sublinear or super-linear ejection direction component between the first and second end electrodes 116 and 118 along a portion of or the entirety of the imaginary ejection surface 138. It should be appreciated that the length of the imaginary ejection surface 138 may vary depending on the implementation. For example, in some embodiments, the imaginary ejection surface 138 is longer in the ejection direction than 2*zₒ. In some embodiments, the imaginary ejection surface 138 equals 2*zₒ. In some embodiments, the imaginary ejection surface 138 is centered and extends the distance between the third and fourth surfaces 130 and 122 along the ejection direction. In some embodiments, the imaginary ejection surface is less than 2*zₒ such that the toroidal ion trap 104 generates an electric field that deviates slightly from the idealized field E_{T} (σ, τ) proximate to the slits 140 and 142.

At block 204, a linear combination of toroidal multipoles is determined that minimizes differences between radial and ejection direction components of an associated field and the idealized field E_{T} (σ, τ). Optionally, as a starting point, a maximum order v for the linear combination of toroidal multipoles is selected. In some embodiments, the maximum order v is at least 7, such that the linear combination of toroidal multipoles includes at least six consecutive toroidal multipoles starting from the second order toroidal multipole. In some embodiments, the maximum order v is greater than 6 (e.g., 7, 8, 9, 10, 11, 12, 13, 14, 15, 16, 17, 18, 19, 20, 21, or even greater). There is no particular limitation on the maximum order v, with the understanding that greater maximum orders may require greater computation times.

In some embodiments, after the maximum order v is selected, a plurality of sets of toroidal even and toroidal odd multipole coefficients aᵥ and bᵥ are used to calculate potentials (e.g., using equation 2 herein) at a plurality of positions within the substantially annular-shaped ion confinement cavity 134. For example, in some embodiments, a grid of σᵢ and τᵢ values are selected that defines a grid including a desired position of the imaginary ejection surface 138 within a toroidal coordinate system. The grid of σᵢ and τᵢ values are used to compute a plurality of potential values Ψ(σᵢ, τᵢ) for each set of toroidal even and toroidal odd multipole coefficients aᵥ and bᵥ. From the plurality of potential values Ψ(σᵢ, τᵢ), radial and ejection direction components Eᵣ(σᵢ, τᵢ) and E_{z}(σᵢ, τᵢ) associated with each set of toroidal even and toroidal odd multipole coefficients aᵥ and bᵥ on the imaginary ejection surface 138 may be computed. The radial and ejection direction components Eᵣ(σᵢ, τᵢ) and E_{z}(σᵢ, τᵢ) may then be compared with the idealized field E_{T} (σ, τ) to identify a set of toroidal even and toroidal odd multipole coefficients aᵥ and bᵥ that provides a least squared error (e.g. using least squares optimization) along the imaginary ejection surface 138. That is, a set of toroidal even and toroidal odd multipole coefficients aᵥ and bᵥ that most closely approximates the idealized field E_{T} (σ, τ) may be selected. In some embodiments, a plurality of iterations of the previously-described technique may be performed in accordance with a suitable optimization technique to identify a set of toroidal even and toroidal odd multipole coefficients aᵥ and bᵥ that generates a field that most closely approximates the idealized field E_{T} (σ, τ). It should be understood that a variety of different techniques may be used to compute the plurality of sets of toroidal even and toroidal odd multipole coefficients aᵥ and bᵥ used to compute radial and ejection direction components Eᵣ(σᵢ, τᵢ) and E_{z}(σᵢ, τᵢ) that are compared to the idealized field E_{T} (σ, τ). For example, sets of toroidal even and toroidal odd multipole coefficients aᵥ and bᵥ may be updated using a differential evolution algorithm, neural networks, or other suitable technique.

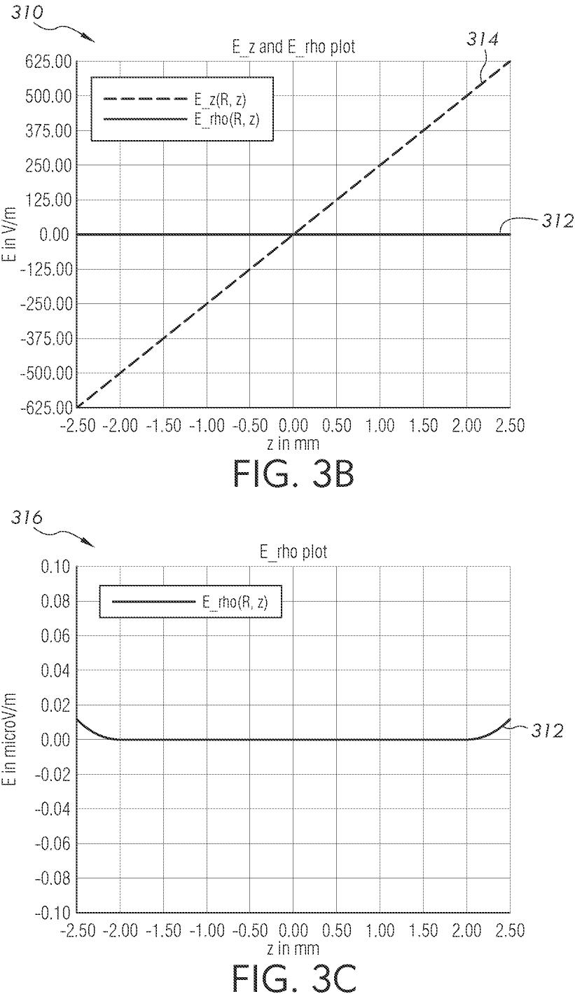

At block 206, positive and negative iso-potential surfaces associated with the linear combination of toroidal multipoles generated using the selected set of toroidal even and toroidal odd multipole coefficients aᵥ and bᵥ are selected for the inner electrode 112, outer electrode 114, first end electrode 116, and second end electrode 118 of the toroidal ion trap 104. FIG. 3A depicts a cross-sectional view of a plot 300 of a plurality of iso-potential surfaces associated with a linear combination of multipoles selected for a design with R=6 mm and zₒ = 2.0 mm. As shown, the plot 300 depicts a plurality of sets of iso-potential surfaces associated with different potential magnitudes (e.g., +/- 0.125 V, +/- 0.25 V, +/- 0.5 V, and +/- 1.0 V). The plurality of sets of iso-potential surfaces includes a first set of iso-potential surfaces associated with a first inner iso-potential surface 302 (e.g., to be used for the inner electrode 112) at a first potential magnitude, a second set of iso-potential surfaces associated with a second inner iso-potential surface 304 (e.g., to be used for the inner electrode 112) at a second potential magnitude, a third set of iso-potential surfaces associated with a third inner iso-potential surface 306 (e.g., to be used for the inner electrode 112) at a third potential magnitude, and a fourth set of iso-potential surfaces associated with a fourth inner iso-potential surface 308 (e.g., to be used for the inner electrode 112) at a fourth potential magnitude. In the example, any of the first, second, third, and fourth inner iso-potential surfaces 302, 304, 306, and 308 may be used for the inner electrode 112 (see FIG. 1B) described herein. As shown, each of the set of iso-potential surfaces includes iso-potential surfaces associated with each electrode having a slightly different geometry. This example demonstrates how various different electrode designs, including electrodes having different shapes, spacing, and configuration, may result from the performance of the methods described herein.

The iso-potential surfaces depicted in the plot 300 were computed using the even and toroidal odd multipole coefficients aᵥ and bᵥ provided in table 1 below.

TABLE 1

| v | aᵥ | bᵥ |
|---|---|---|
| 0 | 0 | 0 |
| 1 | 0 | 0 |
| 2 | 21.607591583119 | 0 |
| 3 | 60.501256483587 | 0 |
| 4 | 116.06363118331 | 0 |
| 5 | 188.08896683991 | 0 |
| 6 | 276.48267802127 | 0 |
| 7 | 381.2028338566 | 0 |
| 8 | 502.0886379489 | 0 |
| 9 | 639.92312513121 | 0 |
| 10 | 786.78775123803 | 0 |
| 11 | 977.734509401 | 0 |
| 12 | 987.96871834908 | 0 |
| 13 | 1466.8450716161 | 0 |

As shown in table 1, the linear combination of toroidal multipoles includes 12 consecutive toroidal harmonics between the second and thirteenth orders. It is beneficial to avoid skipping orders in the linear combination of toroidal multipoles, as consecutive orders cancel out non-linear field curving effects associated with the toroidal design. In some embodiments, the magnitudes of the toroidal even and toroidal odd multipole coefficients aᵥ and bᵥ increase with increasing order in the linear combination of toroidal multipoles. Without wishing to be bound by theory, it is believed that this is due to the higher order multipoles making smaller contributions to the field as compared to lower order multipoles. In order for the higher order multipoles to make a considerable contribution in shaping the overall field generated by the toroidal ion trap 104, the higher magnitudes of toroidal even and toroidal odd multipole coefficients aᵥ and bᵥ are relatively high for the higher order multipoles present in the linear combination. Unwanted contributions of the higher-order toroidal multipoles may be counterbalanced via contributions of the lower order multipoles.

In some embodiments, if the same set of toroidal multipole orders are used, magnitudes of the toroidal even and toroidal odd multipole coefficients aᵥ and bᵥ for different toroidal ion trap designs (e.g., having different R and zₒ values) may be computed from those provided above in table 1. The magnitudes of the toroidal even and toroidal odd multipole coefficients aᵥ and bᵥ may scale with the factor (R/zₒ)², so a toroidal ion trap having R=12.0 mm may have a set of toroidal even and toroidal odd multipole coefficients aᵥ and bᵥ that are four times the values provided above in Table 1.

The linear combination of toroidal multipoles described herein may include the second order toroidal harmonic, as the second order toroidal harmonic provides the trapping field defining the trapping center c of the toroidal ion trap, and thus facilitates formation of the imaginary ejection surface 138. Optionally, ratios of each of the toroidal even and toroidal odd multipole coefficients aᵥ and bᵥ to that associated with the second toroidal harmonic (i.e., a₂) are rational numbers. For example as depicted in Table 1 above, a₃/a₂ = 14/5 = 2.8. In embodiments where the ejection direction component of the idealized field E_{T} (σ, τ) is linear, the quantities aᵥ/a₂ and bᵥ/a₂ are rational numbers that are independent of R/zₒ. That is, other toroidal ion traps, having different values for R and zₒ than those used to compute the coefficients provided in table 1, may also satisfy the relation a₃/a₂ = 14/5 = 2.8. Other ratios aᵥ/a₂ and aᵥ/a₂ may also be independent of R and zₒ. It should be understood that values for these coefficient ratios may vary depending on the particular region of optimization selected for determining the linear combination of toroidal multipoles using the methods described herein.

FIGS. 3B and 3C depict plots 310 and 316 of the electric field generated via electrodes extending along the fourth set of iso-potential surfaces (e.g., associated with the fourth inner iso-potential surface 308 depicted in FIG. 3A) generated using the toroidal even and toroidal odd multipole coefficients aᵥ and bᵥ of Table 1. FIG. 3B depicts a radial component 312 and an ejection direction component 314 as a function of distance from the symmetry plane 136 (see FIG. 1C). FIG. 3C depicts only the radial component 312 with a reduced scale for purpose of visualization. As shown, the radial component is substantially zero (e.g., less than or equal to 0.05 max E) throughout an entirety of the substantially-annular shaped ion confinement cavity 134 between the first and second end electrodes 116 and 118. The ejection component in this example is linear 314 with a slope equal to 5×10⁵ (V/m²).

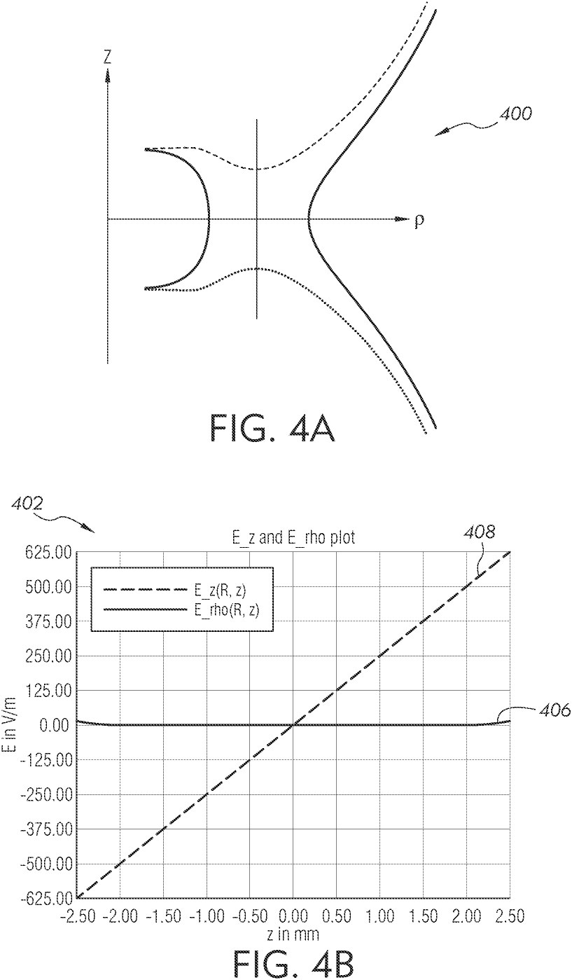

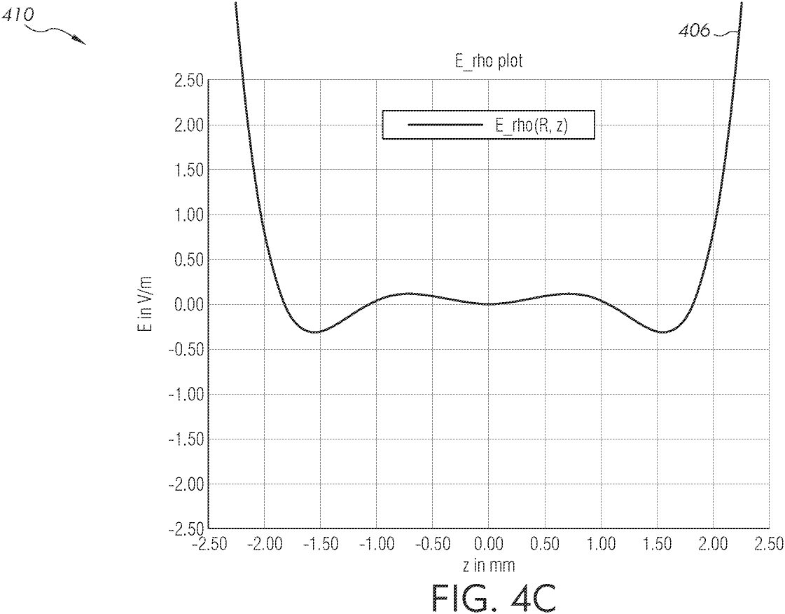

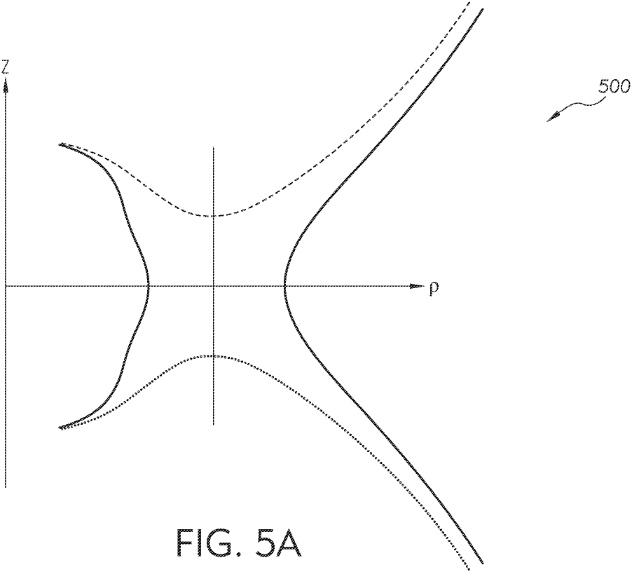

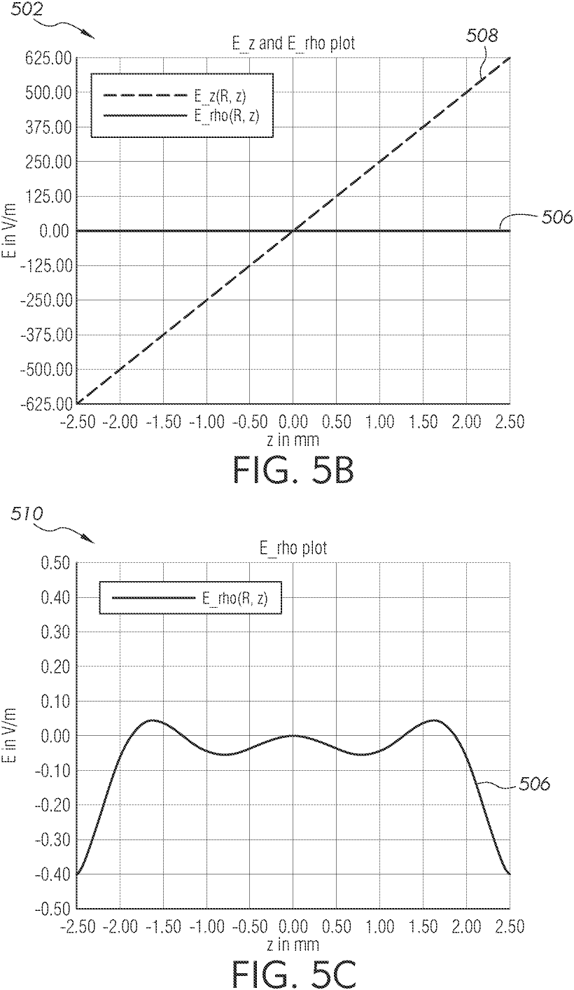

The linear combination of toroidal multipoles used to determine the geometry for the toroidal ion trap 104 may include at least six consecutive toroidal harmonics beginning at the second order toroidal harmonic. FIGS. 4A-4C and 5A-5C describe examples where electrode geometries are determined using linear combinations of toroidal multipoles including five toroidal harmonics and six toroidal harmonics respectively. FIGS. 4A-4C depict a first example toroidal ion trap (having R =6.0 mm and zₒ = 2.0 mm) associated with a first linear combination of toroidal multipoles including five toroidal harmonics. FIG. 4A depicts a plot 400 of iso-potential surfaces associated with the first linear combination of toroidal multipoles. As shown, the geometry for the electrodes is different than that for the toroidal ion trap 104 described herein with respect to FIGS. 1A-1C. FIG. 4B depicts a plot 402 of a radial component 406 and an ejection direction component 408 of the electric field generated via the electrode geometry depicted in FIG. 4A. The radial and ejection direction components 406 and 408 are along an imaginary ejection surface used to determine values for the toroidal even and toroidal odd multipole coefficients aᵥ and bᵥ. FIG. 4C depicts a plot 410 of the radial component 406 with reduced scale for visualization purposes. As depicted in FIG. 4C, the radial component 406 substantially deviates from 0.00 V/m in proximity to the vertices of the end electrodes (e.g., where z is close to +/- 2.00 mm).

FIGS. 5A-5C depict a second example toroidal ion trap (having R =6.0 mm and zₒ = 2.0 mm) associated with a second linear combination of toroidal multipoles including six toroidal harmonics (e.g., the second through the seventh order toroidal harmonics). FIG. 5A depicts a plot 500 of iso-potential surfaces associated with the first linear combination of toroidal multipoles. As shown, the geometry for the electrodes is different than that for the toroidal ion trap 104 described herein with respect to FIGS. 1A-1C. FIG. 5B depicts a plot 502 of a radial component 506 and an ejection direction component 508 of the electric field generated via the electrode geometry depicted in FIG. 5A. The radial and ejection direction components 506 and 508 are along an imaginary ejection surface used to determine values for the toroidal even and toroidal odd multipole coefficients aᵥ and bᵥ. FIG. 5C depicts a plot 510 of the radial component 406 with reduced sale for visualization purposes. As depicted in FIG. 5C, the radial component 506 is less than less than 0.05% of the maximum axial field along the entirety of the distance between the end electrodes along the imaginary ejection surface (optionally less than 0.10 V/m along the entirety of the distance between the end electrodes along the imaginary ejection surface). With reference to FIGS. 5B-5C, a ratio of the radial component 506 to the ejection direction component 508 remains less than or equal to 0.000002 throughout an entirety of the imaginary ejection surface between the end electrodes. Such a radial component to ejection component ratio provides substantial ion trajectory improvements over existing toroidal ion trap designs.

In view of the foregoing, the electrodes of the toroidal ion traps described herein may beneficially include at least six consecutive toroidal harmonics (e.g., including the second order toroidal harmonic to at least the seventh order toroidal harmonic) to facilitate the radial component of the electric field generated thereby having a magnitude of less than or equal to 0.05% of the maximum axial field (optionally less than or equal to 0.05% maximum axial field, or optionally less than or equal to 0.10 V/m) along an entirety of an imaginary ejection surface extending between vertices of the end electrodes thereof. Such linear combinations of toroidal multipoles may also provide ratios of the radial component to the ejection direction component along the imaginary ejection surface to provide improved ion trajectories over existing toroidal ion trap designs.

In the preceding examples, various example sets of electrodes each extended along or through the iso-potential surfaces associated with the linear combination of toroidal multipoles that was used to generate an electric field that approximates the idealized electric field described herein. With reference to FIG. 1C, the slits 140 and 142 of the first and second end electrodes 116 and 118 may cause the electric fields generated via the toroidal ion trap 104 to deviate from the idealized electric field. Such deviations may reduce the performance of the toroidal ion trap. In view of this, in embodiments, the electrodes of the toroidal ion trap 104 may be modified to include inoculation portions that counteract the deviations caused by the slits 140 and 142. Examples of such inoculation portions are described herein with respect to FIG. 8.

Referring now to FIG. 6, a flow diagram of a method 800 of correcting an electrode geometry by including inoculation portions in electrodes of a toroidal ion trap including slits is shown, according to an example embodiment. With reference to FIG. 1C, the method 800 may be performed to determine the shape of inoculation portions to include in first and second end electrodes 116 and 118 to counteract field deviations caused by the slits 140 and 142. Reference will be made to the toroidal ion trap 104 described herein with respect to FIGS. 1A-1F to aid in the description of the method 800.

At block 802, idealized electrode shapes are determined for a toroidal ion trap. In embodiments, the method 200 described herein with respect to FIG. 2B may be performed to generate a linear combination of toroidal multipoles that generates an electric field that approximates the idealized electric field described herein based on a desired size of a toroidal ion trap (e.g., values for the dimensions R and zₒ depicted in FIG. 1C). Radial and ejection direction components of the electric field associated with the linear combination of toroidal multipoles may conform with the restrains described herein along the imaginary ejection surface 138. Iso-potential surfaces associated with the linear combination of toroidal multipoles may be selected and electrode designs for the inner, outer, first end, and second end electrodes 112, 114, 116, and 118 of the toroidal ion trap 104 are then determined.

At block 804, the idealized electrode shapes generated at block 802 are modified to include slits intersecting the imaginary ejection surface 138. For example, as depicted in FIG. 1C, material of the first and second end electrodes 116 and 118 is removed to form the slits 140 and 142. In some embodiments, the slits 140 and 142 are positioned such that the imaginary ejection surface 138 extends through geometric centers (e.g., in the radial direction) of the slits 140 and 142. The slits 140 and 142 may include a slit width in the radial direction. The slit width may, in some embodiments, be less than or equal to 0.5 mm (e.g., less than or equal to 0.45 mm, less than or equal to 0.40 mm, less than or equal to 0.35 mm, less than or equal to 0.33 mm). In some embodiments, maintaining the slit width within the range of 0.33 mm to 0.5 mm beneficially reduces the deviations in the electric field caused by the slits 140 and 142.

At block 806, a modified field generated by the modified idealized electrodes (e.g., including the slits) is determined. A suitable simulation technique, such as a boundary element method, may be employed to estimate an electric field generated via the inner, outer, first end, and second end electrodes 112, 114, 116, and 118 of the toroidal ion trap 104 depicted in FIGS. 1A-1C when voltages are applied to the electrodes. Optionally, the modified electric field may represent the electric field generated as a result of incorporating the slits 140 and 142 into the first and second end electrodes 116 and 118. The radial and ejection direction components of the modified electric field may be compared to the idealized electric field described herein to determine whether inoculation of the electrodes may be avoided. For example, if the radial component of the modified field is still within tolerance as described herein, optionally substantially zero the entirety of the distance between the first and second end electrodes 116 and 118, inoculation may be avoided while still providing an ion trap with improved performance.

At block 808, a deviation field may be generated based on a difference between the modified field computed at block 806 and the initial field generated by the idealized electrodes without the slits. For example, the modified field computed at block 806 may be subtracted from the field produced by the idealized electrodes not including the slits (e.g., the electric field associated with the linear combination of toroidal multipoles) to generate the deviation field. In some embodiments, the deviation field represents the extent that introducing the slits 140 and 142 into the first and second end electrodes 116 and 118 causes the electric field to deviate from the idealized field in the substantially annular-shaped ion confinement cavity 134.

At block 810, the deviation field is added to the initial field (e.g., associated with the idealized electrodes) to generate a correction field. The correction field represents a version of the idealized field that is pre-compensated for the introduction of the slits. Accordingly, at block 812, iso-potential surfaces associated with the correction field are selected to update the surfaces of the inner, outer, first end, and second end electrodes 112, 114, 116, and 118 of the toroidal ion trap 104. In some embodiments, as a result of performing the method 800, each of the first, second, third, and fourth surfaces 120, 122, 130, and 132 may deviate from iso-potential surfaces associated with the linear combination of toroidal multipoles generated via performance of the method 200 described herein with respect to FIG. 2B. The adjustment of the electrode geometries may optionally be confined to the first and second end electrodes 116 and 118. That is, in some embodiments, only the third and fourth surfaces 130 and 132 deviate from the iso-potential surfaces of the linear combination of toroidal multipoles associated with the idealized electrodes.

As an alternative to updating the geometries of each of the first, second, third, and fourth surfaces 120, 122, 130, and 132 by selecting iso-potential surfaces associated with the correction field generated at block 810, regions of the first and second end electrodes 116 and 118 only may be altered in shape to counteract the effects of the slits 140 and 142. For example, in some embodiments, segments of the first and second end electrodes 116 and 118 on either side of the slits 140 and 142, respectively, optionally at any location, may be altered in shape to deviate from the iso-potential lines of the linear combination of toroidal multipoles associated with the idealized electrodes. The segments of the first and second end electrodes 116 and 118 may be modified to extend inward toward one another at locations radially offset from the slits 140 and 142. Optionally, the length and location of the segments that are modified are pre-selected, and the extent that the first and second end electrodes 116 and 118 deviate from the iso-potential surfaces associated with the linear combination of toroidal multipoles may be determined using a suitable optimization technique as described herein. Depending on the location and size of the segments, such a technique may result in the first and second end electrodes 116 and 118 having different shapes.

FIG. 7 depicts an exemplary toroidal ion trap 900 that may result from performing the method 800 of FIG. 6 to modify the toroidal ion trap 104 described herein with respect to FIGS. 1A-1F. Optionally, the toroidal ion trap 900 is a modified version of the toroidal ion trap 104. As described herein, the manner with which the toroidal ion trap 900 differs in geometry from the toroidal ion trap 104 may vary depending on the implementation. In the example shown, iso-potential surfaces associated with the correction field computed at block 810 of the method 800 are selected to determine the geometry of the electrodes of the toroidal ion trap 900. The toroidal ion trap 900 is depicted to differ from the toroidal ion trap 104 of FIG. 1B by including first and second end electrodes 902 and 904 that differ in shape from the first and second end electrodes 116 and 118 described herein. In some embodiments, the toroidal ion trap 900 includes the inner and outer electrodes 112 and 114 of the toroidal ion trap 104. That is the inner and outer electrodes 112 and 114 of the toroidal ion trap 900 may be substantially the same shape (or the same shape) as those described herein with respect to FIGS. 1A-1F.

As depicted in FIG. 7, the first and second end electrodes 902 and 904 include slits 906 and 908 that are similar in shape (e.g., width) to the slits 140 and 142 described herein with respect to FIG. 1C. The first end electrode 902 is depicted to include a first inoculation portion 910 disposed on either side of the slit 906. The second end electrode 904 is depicted to include a second inoculation portion 912 disposed on either side of the slit 908. Optionally, the first and second inoculation portions 910 and 912 include bumps surrounding the slits 906 and 908. Within the first and second inoculation portions 910 and 912, a separation distance between the first and second end electrodes 902 and 904 along the ejection direction as a function of radial position changes at a greater rate than outside of the first and second inoculation portions 910 and 912. That is, within the first and second inoculation portions 910 and 912, the first and second end electrodes 902 and 904 deviate from iso-potential surfaces (depicted in dashed lines) associated with the linear combination of toroidal multipoles used to compute the geometry of the toroidal ion trap. The extent that the first and second end electrodes 902 and 904 (or surfaces thereof) deviate from the iso-potential surfaces associated with the toroidal ion trap 104 is depicted as the variable zᵢₙ in FIG. 7. As shown, in some embodiements, zᵢₙ reaches a maximum value at the boundaries of the slits 906 and 908. In some embodiments, the maximum value is a scaling factor multiplied by the width of the slits 906 and 908. Optionally, the scaling factor is greater than or equal to 0.3 and less than or equal to 0.7 (e.g., 0.30, 0.35, 0.40, 0.45, 0.50, 0.55, 0.60, 0.65, 0.70, and any values therebetween).

As depicted in FIG. 7, ends of the first and second end electrodes 902 and 904 are separated from ends of the inner and outer electrodes 112 and 114 by a minimum electrode separation distance Dₘᵢₙ. In some embodiments, Dₘᵢₙ is greater than or equal to the maximum value of the variable zᵢₙ. Optionally, the minimum electrode separation distance Dₘᵢₙ represents a minimum distance along the ejection direction that portions of the inner and outer electrodes 112 and 114 overlapping the first and second end electrodes 902 and 904 are separated from one another. Maintaining such a relation facilitates maintaining the zₒ value for the ion trap while adding the first and second inoculation portions 910 and 912 proximate to the slits 906 and 908.

While the first and second inoculation portions 910 and 912 in the depicted example are disposed at the boundaries of the slits 906 and 908, it should be appreciated that embodiments are envisioned where the first and second inoculation portions 910 and 912 are offset from the boundaries of the slits 906 and 908 (e.g., in the radial direction). In such embodiments, the first and second end electrodes 902 and 904 may include one or more separate inoculation portions (e.g., bumps or protrusions) disposed on one or both sides of the slits 906 and 908. In some embodiments, inoculation portions may be disposed in any symmetrical or asymmetrical arrangement on either side of the slits 906 and 908 to counteract the field deviations caused by the slits 906 and 908.

While the particular example depicted in FIG. 7 is a modified version of the toroidal ion trap 104 described herein with respect to FIGS. 1A and 1F, it should be understood that the method 800 described herein with respect to FIG. 6 may be performed on any electrode geometry determined in accordance with the methods described herein. Moreover, it should be understood that performance of the method 800 on different initial electrode geometries may result in inoculation portions having shapes that differ from one another. In some embodiments, for example, the greater the value for the dimension R of the imaginary ejection surface, the less the inoculated electrode designs deviate from the iso-potential surfaces associated with the linear combination of toroidal multipoles used to form the idealized electrodes. For example, if R is greater than in the example depicted in FIG. 7, the maximum value of the parameter zᵢₙ may be less than that in the example described above. Different combinations of toroidal multipoles may result in the idealized electrodes having different shapes, resulting in inoculation portions having different geometries than those depicted in FIG. 7.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### EXAMPLES

Example 1: A toroidal ion trap comprising:
an inner electrode comprising a first surface;
an outer electrode at least partially circumferentially surrounding the inner electrode, the outer electrode comprising a second surface substantially facing the first surface, wherein the outer electrode is spaced apart from the first surface in a radial direction;
a first end electrode comprising a third surface;
a second end electrode comprising a fourth surface substantially facing the third surface;
an axis of rotation extending through the inner electrode; and wherein:
   the first, second, third, and fourth surfaces define a substantially annular-shaped ion confinement cavity circumferentially surrounding the axis of rotation, and
   at least portions of each of the first, second, third, and fourth surfaces extend through or along iso-potential surfaces associated with a linear combination of toroidal multipoles to generate an electric field extending through slits in the first and second end electrodes, wherein a linear combination of toroidal multipoles comprises at least six consecutive toroidal harmonics starting at a second order toroidal harmonic.

Example 2: The toroidal ion trap according to example 1, wherein the linear combination of toroidal multipoles is selected such that, when voltages are applied to the inner, outer, first end, and second end electrodes, a radial component of an electric field extending along an imaginary ejection surface extending between the slits is substantially zero.

Example 3: The toroidal ion trap according to example 2, wherein the linear combination of toroidal multipoles is selected such that, when the voltages are applied to the inner, outer, first end, and second end electrodes, an ejection direction component of the electric field along the imaginary ejection surface is linear or super-linear.

Example 4: The toroidal ion trap according to example 1, wherein:
the linear combination of toroidal multipoles is computed by multiplying a plurality of toroidal multipole coefficients by a plurality of orders or toroidal harmonics, and
ratios of each of the toroidal multipole coefficients to the toroidal multipole coefficient associated with the second order toroidal harmonic are rational numbers.

Example 5: The toroidal ion trap according to example 4, wherein the plurality of multipole coefficients increase in magnitude as the order of the order of the toroidal harmonic in the linear combination of toroidal multipoles increases.

Example 6: The toroidal ion trap according to example 1 further comprising a symmetry plane extending perpendicular to the axis of rotation through the inner electrode and the outer electrode between the first end electrode and the second end electrode.

Example 7: The toroidal ion trap according to example 6, wherein at least one of:
one or more of the first, second, third, and fourth surfaces comprise inflection points that are displaced from the symmetry plane, the axis of rotation, and an imaginary ejection surface extending between the inner and outer electrodes along an ejection direction that is parallel to the axis of rotation; and
the inner electrode, outer electrode, first end electrode, and second end electrode are truncated such that end portions thereof do not overlap with one another along the ejection direction.

Example 8: The toroidal ion trap according to example 7, wherein:
the inner electrode comprises a first vertex extending in the ejection direction at a first radial position r₁;
the outer electrode comprises a second vertex extending in the ejection direction at a second radial position r₂; and
the imaginary ejection surface is disposed a radial distance R from the axis of rotation that is greater than r₁ and less than or equal to r₂.

Example 9: The toroidal ion trap according to example 7, wherein R is greater than or equal to 2.0 mm and less than or equal 12.0 mm.

Example 10: The toroidal ion trap according to example 7, wherein:
the first surface comprises first pair of inflection points that are disposed a distance Z_{IF} in the ejection direction from the plane of symmetry; and
peaks of the first and second end electrodes are positioned along the imaginary ejection surface a distance zₒ in the direction parallel to the axis of rotation from the plane of symmetry.

Example 11: The toroidal ion trap according to example 10, wherein:
R is less than 2.1 times zₒ and Z_{IF} is less than zₒ; or
R is greater than 2.1 times zₒ and Z_{IF} is greater than zₒ.

Example 12: The toroidal ion trap according to example 10, wherein the third and fourth surfaces comprise inoculation portions where a separation distance between the third and fourth surfaces along the ejection direction as a function of radial position changes at a greater rate than outside of the inoculation portions.

Example 13: The toroidal ion trap according to example 12, wherein:
within the inoculation portions, the third and fourth surfaces deviate from the iso-potential surfaces extend by a distance zᵢₙ in the ejection direction; and
the first and second end electrodes are separated from the inner and outer electrodes by at least a maximum value of the distance zᵢₙ.

Example 14: The toroidal ion trap according to example 13, wherein:
the inoculation portions comprise bumps surrounding the slits; and optionally
widths of the inoculation portions in the radial direction equal a width of the slits multiplied by a conversion factor that is greater than or equal to 0.3 and less than or equal to 0.7.

Example 15: A toroidal ion trap comprising:
a first end electrode comprising a first surface;
a second end electrode comprising a second surface that is spaced apart from the first surface along an ejection direction, wherein the first and second end electrodes comprise mirror images of one another and are arranged equidistantly from a mirror plane by a distance zₒ;
an inner electrode disposed radially inward of peaks of the first and second surfaces;
an outer electrode disposed radially outward of the peaks;
a direct current (“DC”) voltage source conductively connected to the first and second end electrodes; and
a radio frequency (“RF”) voltage source conductively connected to the inner and outer electrodes, wherein the first end electrode, second end electrode, inner electrode, and outer electrode are shaped such that, in response to a RF voltage being applied to the inner and outer electrodes via the RF voltage source and a DC voltage being applied to the first and second end electrodes via the DC voltage source, an electric field is generated, the electric field comprising a radial component at a distance R from an axis of rotation that is substantially zero between the first and second end electrodes.

Example 16: The toroidal ion trap according to example 15, wherein the electric field comprises a z-component in a direction parallel to the axis of rotation that increases in magnitude linearly or super-linearly with increasing distance from the mirror plane.

Example 17: The toroidal ion trap according to example 15, wherein the first and second end electrodes comprise slits at the distance R from the axis of rotation.

Example 18: The toroidal ion trap according to example 17, wherein:
the first end electrode, the second end electrode, the inner electrode, and the outer electrode comprise portions extending along or through iso-potential surfaces associated with a linear combination of toroidal multipoles;
the first and second end electrodes comprise inoculation portions surrounding the slits;
within the inoculation portions, the first and second surfaces deviate from the iso-potential surfaces by a distance zᵢₙ at boundaries of the slits; and
the first and second end electrodes are separated from the inner and outer electrodes by at least the distance zᵢₙ.

Example 19: A method of determining an electrode geometry for a toroidal ion trap, the method comprising:
determining a linear combination of toroidal multipoles in a toroidal coordinate system that generates an electric field having a radial component equal to zero along an imaginary ejection surface extending through a line r = R, wherein the electric field has the radial component equal to zero for at least a distance 2*zₒ along an ejection direction;
generating a plurality of iso-potential surfaces from the linear combination of toroidal multipoles; and
selecting positive and negative iso-potential surfaces of the plurality of iso-potential surfaces for surfaces of end electrodes, an outer electrode, and an inner electrode for the toroidal ion trap, wherein the positive and negative iso-potential surfaces selected for the end electrodes are separated by at most the distance 2*zₒ and positioned such that the imaginary ejection surface at least partially extends therethrough.

Example 20: The method of example 19, wherein the determining the linear combination of the toroidal multipoles comprises utilizing a least squared algorithm to determine a combination of toroidal multipoles that generates the electric field.

Example 21: The method of example 20, further comprising:
altering the end electrodes to form altered end electrodes;
determining a modified field generated by a toroidal ion trap comprising the altered end electrodes;
subtracting the modified field from an initial field generated by the toroidal ion trap without the altered end electrodes to generate a deviation field;
add the deviation field to the initial field to generate a correction field; and
selecting iso-potential surfaces associated with the correction field to update the surfaces.

Example 22: The method of example 21 wherein said altering is by including slits along the line r = R.

Example 23: The method of example 22, wherein said subtracting is by subtracting the modified field from the initial field generated by the toroidal ion trap without the slits to generate a deviation field.

It should now be understood that embodiments described herein are directed to toroidal ion traps including electrodes that extend along or at least partially through iso-potential surfaces that are associated with electric fields designed to improve ion ejection directions over existing ion traps. The iso-potential surfaces may be based at least in part on a linear combination of toroidal multipoles selected to generate an electric field along an imaginary ejection surface extending perpendicular to mirror plane of the toroidal ion trap. The electric field may include a radial component along the imaginary ejection surface that is substantially zero and an ejection direction component that varies linearly with distance from the mirror plane. Inoculation portions of the electrodes may deviate from the iso-potential surfaces associated with the linear combination of toroidal multipoles to counteract field deviations caused by introducing slits or truncations into end electrodes.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A toroidal ion trap comprising:
an inner electrode comprising a first surface;
an outer electrode at least partially circumferentially surrounding the inner electrode, the outer electrode comprising a second surface substantially facing the first surface, wherein the outer electrode is spaced apart from the first surface in a radial direction;
a first end electrode comprising a third surface;
a second end electrode comprising a fourth surface substantially facing the third surface;
an axis of rotation extending through the inner electrode; and wherein:
the first, second, third, and fourth surfaces define a substantially annular-shaped ion confinement cavity circumferentially surrounding the axis of rotation, and
at least portions of each of the first, second, third, and fourth surfaces extend through or along iso-potential surfaces associated with a linear combination of toroidal multipoles to generate an electric field extending through slits in the first and second end electrodes, wherein a linear combination of toroidal multipoles comprises at least six consecutive toroidal harmonics starting at a second order toroidal harmonic.

2. The toroidal ion trap according to claim 1, wherein the linear combination of toroidal multipoles is selected such that, when voltages are applied to the inner, outer, first end, and second end electrodes, a radial component of an electric field extending along an imaginary ejection surface extending between the slits is less than 0.05% a maximum electric field along the imaginary ejection surface.

3. The toroidal ion trap according to claim 2, wherein the linear combination of toroidal multipoles is selected such that, when the voltages are applied to the inner, outer, first end, and second end electrodes, an ejection direction component of the electric field along the imaginary ejection surface is linear or super-linear.

4. The toroidal ion trap according to claim 1, wherein:
the linear combination of toroidal multipoles is computed by multiplying a plurality of toroidal multipole coefficients by a plurality of orders or toroidal harmonics, and optionally
ratios of each of the toroidal multipole coefficients to the toroidal multipole coefficient associated with the second order toroidal harmonic are rational numbers.

5. The toroidal ion trap according to claim 4, wherein the plurality of multipole coefficients increase in magnitude as the order of the order of a toroidal harmonic in the linear combination of toroidal multipoles increases.

6. The toroidal ion trap according to claim 1 further comprising a symmetry plane extending substantially perpendicular to the axis of rotation through the inner electrode and the outer electrode between the first end electrode and the second end electrode.

7. The toroidal ion trap according to claim 6, wherein at least one of:
one or more of the first, second, third, and fourth surfaces comprise inflection points that are displaced from the symmetry plane, the axis of rotation, and an imaginary ejection surface extending between the inner and outer electrodes along an ejection direction that is parallel to the axis of rotation; and
the inner electrode, outer electrode, first end electrode, and second end electrode are truncated such that end portions thereof do not overlap with one another along the ejection direction.

8. The toroidal ion trap according to claim 7, wherein:
the inner electrode comprises a first vertex extending in the ejection direction at a first radial position r₁;
the outer electrode comprises a second vertex extending in the ejection direction at a second radial position r₂; and
the imaginary ejection surface is disposed a radial distance R from the axis of rotation that is greater than r₁ and less than or equal to r₂.

9. The toroidal ion trap according to claim 7, wherein R is greater than or equal to 1.0 mm and less than or equal 12.0 mm.

10. The toroidal ion trap according to claim 7, wherein:
the first surface comprises first pair of inflection points that are disposed a distance Z_{IF} in the ejection direction from a plane of symmetry; and
peaks of the first and second end electrodes are positioned along the imaginary ejection surface a distance zₒ in the direction parallel to the axis of rotation from the plane of symmetry.

11. The toroidal ion trap according to claim 10, wherein:
R is less than 2.1 times zₒ and Z_{IF} is less than zₒ; or
R is greater than 2.1 times zₒ and Z_{IF} is greater than zₒ.

12. The toroidal ion trap according to claim 10, wherein the third and fourth surfaces comprise inoculation portions where a separation distance between the third and fourth surfaces along the ejection direction as a function of radial position changes at a greater rate than outside of the inoculation portions.

13. The toroidal ion trap according to claim 12, wherein:
within the inoculation portions, the third and fourth surfaces deviate from the iso-potential surfaces extend by a distance zᵢₙ in the ejection direction; and
the first and second end electrodes are separated from the inner and outer electrodes by at least a maximum value of the distance zᵢₙ.

14. The toroidal ion trap according to claim 13, wherein:
the inoculation portions comprise bumps surrounding the slits; and optionally
widths of the inoculation portions in the radial direction equal a width of the slits multiplied by a conversion factor that is greater than or equal to 0.3 and less than or equal to 0.7.

15. A toroidal ion trap comprising:
a first end electrode comprising a first surface;
a second end electrode comprising a second surface that is spaced apart from the first surface along an ejection direction, wherein the first and second end electrodes comprise mirror images of one another and are arranged equidistantly from a mirror plane by a distance zₒ;
an inner electrode disposed radially inward of peaks of the first and second surfaces;
an outer electrode disposed radially outward of the peaks;
a direct current (“DC”) voltage source conductively connected to the first and second end electrodes; and
a radio frequency (“RF”) voltage source conductively connected to the inner and outer electrodes, wherein the first end electrode, second end electrode, inner electrode, and outer electrode are shaped such that, in response to a RF voltage being applied to the inner and outer electrodes via the RF voltage source and a DC voltage being applied to the first and second end electrodes via the DC voltage source, an electric field is generated, the electric field comprising a radial component at a distance R from an axis of rotation that is equal to or less than 0.05% the maximum electric field in an axial direction of the ion trap between the first and second end electrodes, optionally entirely between the first and second electrodes.

16. The toroidal ion trap according to claim 15, wherein the electric field comprises a z-component in a direction parallel to the axis of rotation that increases in magnitude linearly or super-linearly with increasing distance from the mirror plane.

17. The toroidal ion trap according to claim 15, wherein the first and second end electrodes comprise slits at the distance R from the axis of rotation.

18. The toroidal ion trap according to claim 17, wherein:
the first end electrode, the second end electrode, the inner electrode, and the outer electrode comprise portions extending along or through iso-potential surfaces associated with a linear combination of toroidal multipoles;
the first and second end electrodes comprise inoculation portions surrounding the slits;
within the inoculation portions, the first and second surfaces deviate from the iso-potential surfaces by a distance zᵢₙ at boundaries of the slits; and
the first and second end electrodes are separated from the inner and outer electrodes by at least a distance zᵢₙ.

19. A method of determining an electrode geometry for a toroidal ion trap, the method comprising:
determining a linear combination of toroidal multipoles in a toroidal coordinate system that generates an electric field having a radial component equal to zero along an imaginary ejection surface extending through a line r = R, wherein the electric field has the radial component equal to zero for at least a distance 2∗zₒ along an ejection direction;
generating a plurality of iso-potential surfaces from the linear combination of toroidal multipoles; and
selecting positive and negative iso-potential surfaces of the plurality of iso-potential surfaces for surfaces of end electrodes, an outer electrode, and an inner electrode for the toroidal ion trap, wherein the positive and negative iso-potential surfaces selected for the end electrodes are separated by at most the distance 2∗zₒ and positioned such that the imaginary ejection surface at least partially extends therethrough.

20. The method of claim 19, wherein the determining a linear combination of the toroidal multipoles comprises utilizing a least squared algorithm to determine a combination of toroidal multipoles that generates the electric field.

21. The method of claim 20, further comprising:
altering the end electrodes to form altered end electrodes;
determining a modified field generated by a toroidal ion trap comprising the altered end electrodes;
subtracting the modified field from an initial field generated by the toroidal ion trap without the altered end electrodes to generate a deviation field;
add the deviation field to the initial field to generate a correction field; and
selecting iso-potential surfaces associated with the correction field to update the surfaces.

22. The method of claim 21, wherein said altering is by including slits along the line r = R.

23. The method of claim 22, wherein said subtracting is by subtracting the modified field from the initial field generated by the toroidal ion trap without the slits to generate a deviation field.
